(19) United States
(12) Patent Application Publication
(10) Pub. No.: US 2007/0099651 A1
(43) Pub. Date: May 3, 2007

(54) Hold on telephony feature

(75) Inventor: Timothy John Strasser, Holly Springs, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/265,907

(22) Filed: Nov. 3, 2005

(51) Int. Cl. H04M 1/00

(52) U.S. Cl. 455/550.1

(57) ABSTRACT

The present invention allows a communication terminal to implement a hold on feature upon receiving an incoming call. Upon receiving an incoming call, the communication terminal may initiate an incoming call alert to the user, and in response, receive a hold on instruction. Upon receiving the hold on instruction, the communication terminal will answer the incoming call and deliver a hold on message to the caller in an automated fashion. While the hold on feature is active, the voice interface through which the user will speak and listen during a call may be muted. The user can subsequently engage in the conversation, wherein the muting is removed to effectively connect the voice path to the voice interface, such that the call can proceed in traditional fashion.

### FIELD OF THE INVENTION

The present invention relates to telephony communications, and in particular to providing a hold on feature.

### BACKGROUND OF THE INVENTION

Mobile telephones have made telephony communications possible at virtually any time and in any place. In many instances, a telephony user is in a situation where answering a call is either impossible, difficult, or inappropriate at her given location or in her given situation. For example, one may find it inappropriate to answer a call in a public area such as a restaurant or movie theater, during a meeting, or while driving in heavy traffic. In an effort to avoid missing the call, these users often try to discreetly answer the call and let the caller know that there may be a few seconds before a normal conversation can ensue. It is very common for meeting participants to receive a call and then dart out of the conference room in an effort to avoid missing a call. In other situations, the call is actually answered, but the user must delay in speaking to the caller until the user has reached an appropriate location at which to carry on a conversation. Accordingly, there is a need for a technique to allow a user to effectively answer a call and be afforded sufficient time to reach a location where engaging in conversation with the caller is appropriate. There is a further need for a way to alert the caller that there will be a delay prior to being able to engage in conversation with the user. It would be preferable to provide these techniques without requiring the user to speak to the caller before reaching an appropriate location, as well as minimize the actions required by the user to initiate these techniques.

### SUMMARY OF THE INVENTION

The present invention allows a communication terminal to implement a hold on feature upon receiving an incoming call. Upon receiving an incoming call, the communication terminal may initiate an incoming call alert to the user, and in response, receive a hold on instruction. Upon receiving the hold on instruction, the communication terminal will answer the incoming call and deliver a hold on message to the caller in an automated fashion. While the hold on feature is active, the voice interface through which the user will speak and listen during a call may be muted. The user can subsequently engage in the conversation, wherein the muting is removed to effectively connect the voice path to the voice interface, such that the call can proceed in traditional fashion.

The communication terminal may be configured with multiple hold on messages, which may be selected for different people or based on different circumstances. The hold on messages may be selected in a dynamic fashion for each incoming call by the user, as well as being automatically selected by the communication terminal based on various criteria, such as caller identification information provided in association with the incoming call. The hold on feature allows users to have an incoming call answered, wherein an automatic message is provided to the caller until the user can engage in conversation.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication terminal according to one embodiment of the present invention.

FIGS. 2A and 2B are a flow diagram illustrating operation of a communication terminal according to one embodiment of the present invention.

FIG. 3 is a block representation of a wireless communication terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a “hold on” telephony feature. The hold on telephony feature allows a user of a communication terminal to have the communication terminal answer an incoming call and effectively put the caller on hold. After the communication terminal answers the call, a message is provided to the caller to indicate that she has been placed on hold, or that the called party will engage in the call in short order. While the hold on feature is active, the communication terminal may effectively mute any associated microphones or speakers, such that the caller cannot hear noises or conversation within range of the communication terminal, and the called party cannot hear the brief message or any noises or audible information associated with the caller. When the called party is ready to take the call, the communication terminal will effectively take the call off hold and allow normal operation to begin, wherein the caller and called party can engage in a conversation.

The hold on message provided to the caller when the hold on feature is activated may be a generic message provided by the communication terminal, or one recorded by the called party and stored in the communication terminal. Further, the called party may select one of a number of hold on messages depending on the caller, such that the called party's spouse, children, boss, friends, or subordinates may receive different hold on messages. The particular message may be selected by the called party or automatically by the communication terminal based on caller identification information. Activating the hold on feature when answering the call and deactivating the hold on feature when the called party is ready to engage in conversation may be selected by having the called party select a hard or soft key, as will be appreciated by those skilled in the art.

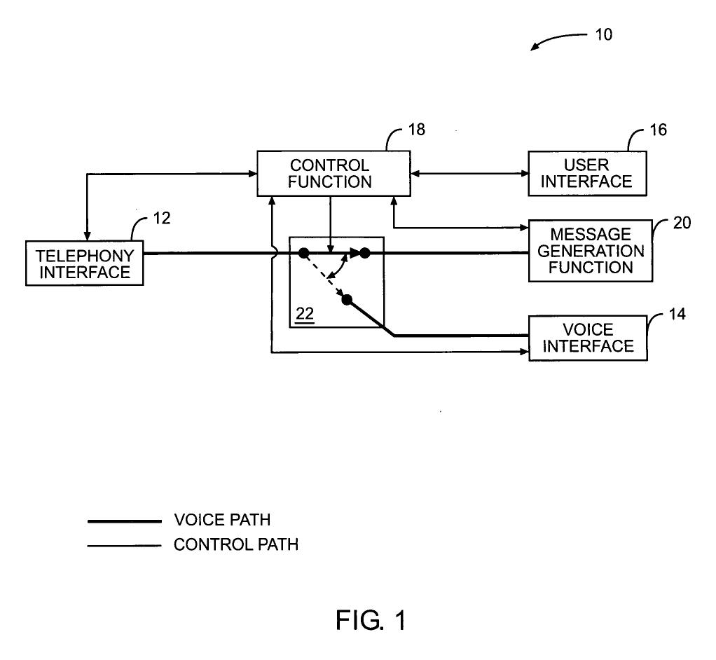

With reference to FIG. 1, a functional block representation of a communication terminal 10 is illustrated. The communication terminal 10 will include a telephony interface 12 for facilitating wired or wireless communications over an appropriate communication network, as well as a voice interface 14 and a user interface 16. The voice interface 14 will include the traditional microphone, speaker, and associated audio electronics to allow the called party to listen to and speak to the caller. The user interface 16 may include the traditional keypad and display, which allow the user to receive textual information as well as provide various inputs based on hard and soft key technologies. A control function 18 provides the basic control for the communication terminal 10, and is adapted to cooperate with the telephony interface 12, voice interface 14, and user interface 16 to facilitate traditional telephony functionality.

For the present invention, the communication terminal 10 provides the hold on function by providing a message generation function 20 and audio control function 22, as well as by adding additional functionality to the control function 18. As illustrated for functional representation purposes only, the voice path to the telephony interface 12 is selectively connected to either the message generation function 20 or the voice interface 14, depending on whether the on hold feature is active. Upon receiving an incoming call, a user input selecting the hold on feature from the user interface 16 is recognized by the control function 18, which will instruct the telephony interface 12 to answer the call, instruct the audio control function 22 to connect the voice path to the message generation function 20, and instruct the message generation function 20 to provide an audible message to the caller. As depicted, the voice path is essentially disconnected, or muted, from the voice interface 14. When the called party is ready to take the call, an appropriate input is received at the user interface 16 and passed to the control function 18, which will cause the audio control function 22 to connect the voice path leading to the telephony interface 12 to the voice interface 14, wherein the called party can engage in a bidirectional voice call with the caller.

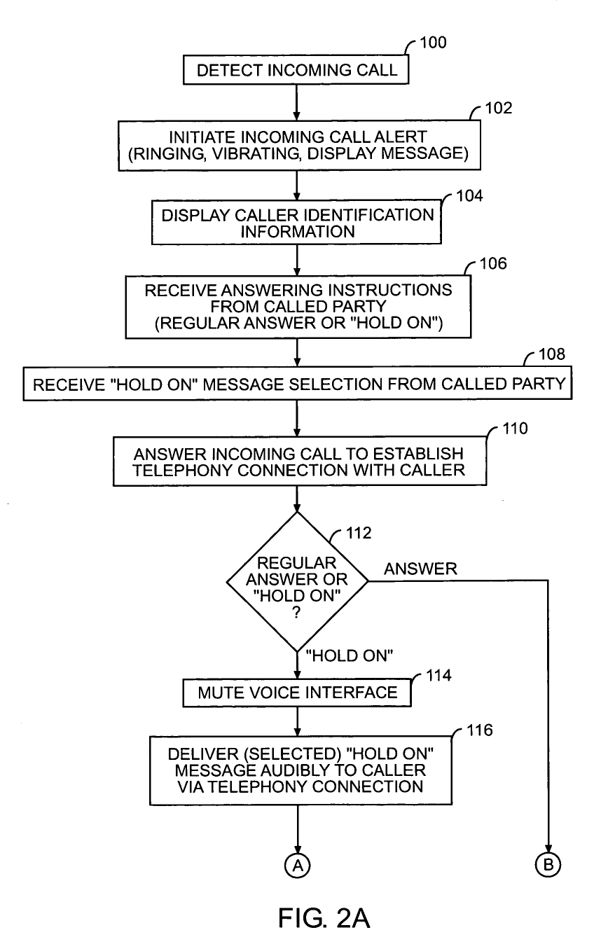

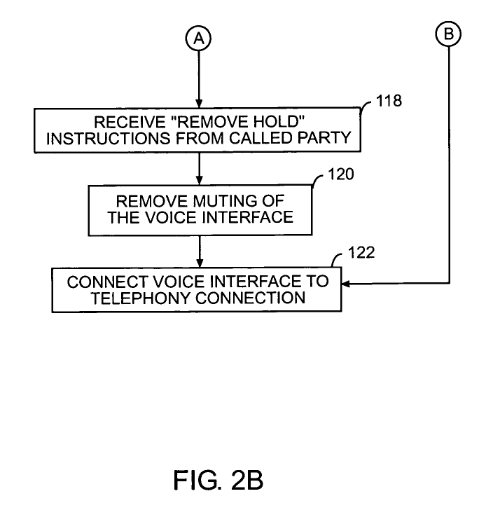

With reference to FIGS. 2A and 2B, an exemplary flow diagram illustrating operation of a communication terminal 10 according to one embodiment of the invention is provided. Initially, the communication terminal 10 will detect an incoming call (step 100) and initiate an incoming call alert, such as causing the communication terminal 10 to ring, vibrate, or display a message alerting the called party to the incoming call (step 102). If caller identification information is available, the communication terminal 10 may display the caller identification information to the called party (step 104). Assuming the called party wishes to answer the call, the communication terminal 10 will receive answering instructions from the called party (step 106). These instructions may be to either answer the incoming call in a regular fashion or activate the hold on feature. If the hold on feature is selected and there are multiple hold on messages from which the called party may choose, the communication terminal 10 may receive a hold on message selection from the called party (step 108).

Next, the communication terminal 10 will answer the incoming call to establish a telephony connection with the caller via the telephony interface 12 (step 110). If the hold on feature was selected by the called party (step 112), the communication terminal 10 will effectively mute the voice interface (step 114) and cause the message generation function 20 to deliver the hold on message in an audible fashion to the caller via the telephony connection (step 116). If only one hold on message is available, then that hold on message will be provided to the caller. If multiple hold on messages are available, the selected hold on message will be provided to the caller. Although not illustrated, selection of a hold on message from multiple hold on messages may be provided automatically by the communication terminal 10 based on various criteria, including caller identification information received when the incoming call is presented to the communication terminal 10. After the hold on message is delivered to the caller, the communication terminal 10 will maintain the telephony connection and keep the voice interface 14 muted. Those skilled in the art will recognize numerous techniques for muting the voice interface. Further, in certain embodiments, muting may not be employed, or either the microphone or speaker aspects of the voice interface 14 may be muted.

When the called party is ready to engage the call, an appropriate input is provided to the user interface 16, wherein the communication terminal 10 will effectively receive “remove hold” instructions from the called party (step 118) and remove any muting of the voice interface 14 (step 120). The communication terminal 10 will then ensure that the voice interface 14 is connected to the telephony interface 12 in traditional fashion to support bidirectional voice communications in traditional fashion (step 122). If the incoming call was answered without activating the hold on feature, (step 112), the communication terminal 10 will connect the call in normal fashion (step 122).

As noted, the concepts of the present invention may be implemented in wired or wireless communication terminals. Further, the communication terminals may employ traditional circuit-switched or packet-based communication techniques. The communication terminals may be mobile or substantially fixed. The following description provides a basic architecture for a mobile terminal, such as a mobile telephone, personal digital assistant, or other voice-capable communication client.

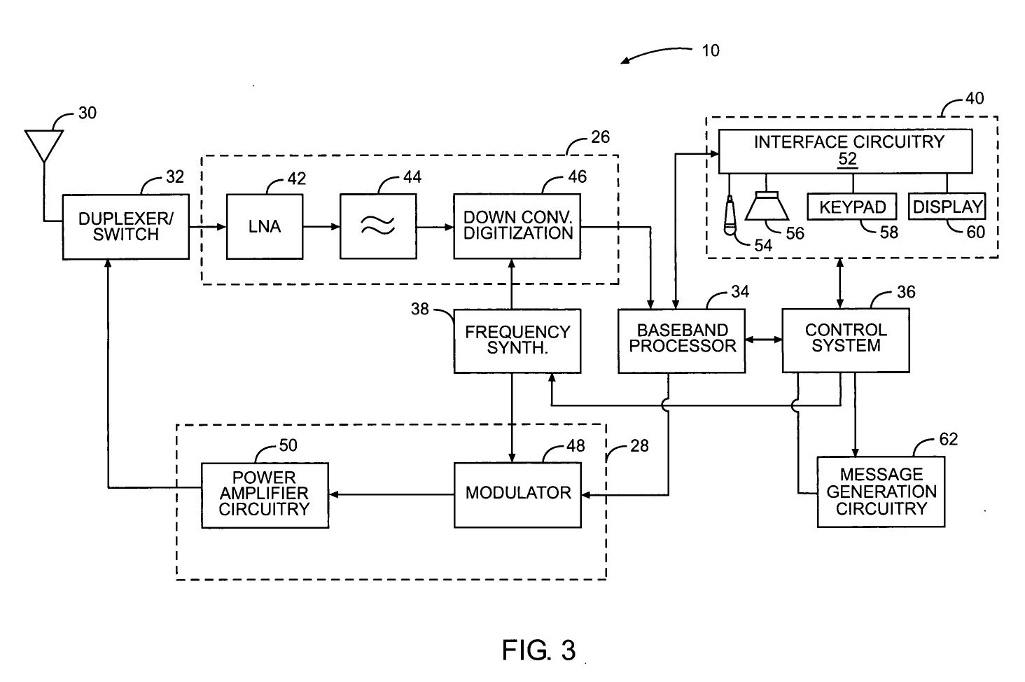

The basic architecture of a mobile terminal 24 is represented in FIG. 3 and may include a receiver front end 26, a radio frequency transmitter section 28, an antenna 30, a duplexer or switch 32, a baseband processor 34, a control system 36, a frequency synthesizer 38, and an interface 40. The receiver front end 26 receives information bearing radio frequency signals from one or more remote transmitters provided by a base station. A low noise amplifier 42 amplifies the signal. A filter circuit 44 minimizes broadband interference in the received signal, while downconversion and digitization circuitry 46 downconverts the filtered, received signal to an intermediate or baseband frequency signal, which is then digitized into one or more digital streams. The receiver front end 26 typically uses one or more mixing frequencies generated by the frequency synthesizer 38. The baseband processor 34 processes the digitized received signal to extract the information or data bits conveyed in the received signal. This processing typically comprises demodulation, decoding, and error correction operations. As such, the baseband processor 34 is generally implemented in one or more digital signal processors (DSPs).

On the transmit side, the baseband processor 34 receives digitized data, which may represent voice, data, or control information, from the control system 36, which it encodes for transmission. The encoded data is output to the transmitter 28, where it is used by a modulator 48 to modulate a carrier signal that is at a desired transmit frequency. Power amplifier circuitry 50 amplifies the modulated carrier signal to a level appropriate for transmission, and delivers the amplified and modulated carrier signal to the antenna 30 through the duplexer or switch 32.

A user may interact with the mobile terminal 24 via the interface 40, which may include interface circuitry 52 associated with a microphone 54, a speaker 56, a keypad 58, and a display 60. The interface circuitry 52 typically includes analog-to-digital converters, digital-to-analog converters, amplifiers, and the like. Additionally, it may include a voice encoder/decoder, in which case it may communicate directly with the baseband processor 34. The microphone 54 will typically convert audio input, such as the user's voice, into an electrical signal, which is then digitized and passed directly or indirectly to the baseband processor 34. Audio information encoded in the received signal is recovered by the baseband processor 34, and converted by the interface circuitry 52 into an analog signal suitable for driving the speaker 56. The keypad 58 and display 60 enable the user to interact with the mobile terminal 24, input numbers to be dialed, address book information, or the like, as well as activate the hold on feature and deactivate the hold on feature to engage the call.

The control system 36 may be associated with message generation circuitry 62, which is adapted to provide the message generation function 20. In operation, the message generation circuitry 62 can provide the hold on message to the baseband processor 34, which will send the hold on message in an audible format to the transmitter section 28 for transmission to the caller once a hold on feature has been invoked. The baseband processor 34, under control of the control system 36, may provide the audio control function 22 to effectively connect the telephony connection established for the incoming call to the message generation circuitry 62 or the called party via the interface 40. The baseband processor 34 can also provide any desired muting by controlling the information that is provided to the interface 40 and the transmitter section 28. Again, those skilled in the art will recognize other ways to implement the concepts of the present invention.

Those skilled in the art will recognize improvements and modifications to the preferred embodiments of the present invention. All such improvements and modifications are considered within the scope of the concepts disclosed herein and the claims that follow.

What is claimed is:

1. A communication terminal adapted to provide a hold on feature for incoming calls comprising:
a telephony interface adapted to facilitate a telephone call;
a voice interface adapted to facilitate audible communications with a user for the telephone call; and
a control system associated with the telephony interface and the voice interface and adapted to:
answer an incoming call to establish a telephony connection via the telephony interface;
effect delivery of a hold on message to a caller over the telephony connection upon establishing the telephony connection; and
establish a voice path for the telephony connection to the voice interface such that the user can engage in conversation with the caller.

2. The communication terminal of claim 1 further comprising a user interface adapted to receive user input, the control system further adapted to receive a hold on instruction via the user interface from the user in response to the incoming call, wherein the hold on feature is initiated upon receiving the hold on instruction.

3. The communication terminal of claim 1 wherein the control system is further adapted to select the hold on message from a plurality of hold on messages.

4. The communication terminal of claim 3 further comprising a user interface adapted to receive user input, the control system further adapted to receive a selection input via the user interface from the user, wherein the selection input determines the one of the plurality of hold on messages selected as the hold on message delivered to the caller.

5. The communication terminal of claim 4 wherein the control system is further adapted to receive a hold on instruction via the user interface from the user in response to the incoming call, wherein the hold on feature is initiated upon receiving the hold on instruction.

6. The communication terminal of claim 5 wherein the hold on instruction and the user input are provided by one user input.

7. The communication terminal of claim 3 wherein the control system is further adapted to select the hold on message from the plurality of hold on messages based on caller identification information received in association with the incoming call.

8. The communication terminal of claim 1 wherein the control system is further adapted to mute the voice interface while the hold on feature is active.

9. The communication terminal of claim 8 wherein the control system is further adapted to remove muting of the voice interface to allow the user to engage in conversation with the caller upon receiving an indication to deactivate the hold on feature.

10. The communication terminal of claim 1 further comprising a user interface adapted to receive user input, the control system further adapted to receive an engage instruction via the user interface after the hold on feature is activated in response to the incoming call, wherein the voice path is established upon receiving the engage instruction.

11. The communication terminal of claim 1 further comprising voice generation circuitry associated with the control system and adapted to store and deliver the hold on message to the caller via the telephony connection.

12. A method for providing a hold on feature for incoming calls comprising:
answering an incoming call to establish a telephony connection via a telephony interface;
effecting delivery of a hold on message to a caller over the telephony connection upon establishing the telephony connection; and
establishing a voice path for the telephony connection to a voice interface such that the user can engage in conversation with the caller.

13. The method of claim 12 further comprising receiving a hold on instruction from the user in response to the incoming call, wherein the hold on feature is initiated upon receiving the hold on instruction.

14. The method of claim 12 further comprising selecting the hold on message from a plurality of hold on messages.

15. The method of claim 14 further comprising receiving a selection input from the user, wherein the selection input determines the one of the plurality of hold on messages selected as the hold on message delivered to the caller.

16. The method of claim 15 further comprising receiving a hold on instruction from the user in response to the incoming call, wherein the hold on feature is initiated upon receiving the hold on instruction.

17. The method of claim 16 wherein the hold on instruction and the user input are provided by one user input.

18. The method of claim 14 further comprising selecting the hold on message from the plurality of hold on messages based on caller identification information received in association with the incoming call.

19. The method of claim 12 further comprising muting a voice interface while the hold on feature is active.

20. The method of claim 19 further comprising removing the muting of the voice interface to allow the user to engage in conversation with the caller upon receiving an indication to deactivate the hold on feature.

21. The method of claim 12 further comprising receiving an engage instruction from the user after the hold on feature is activated in response to the incoming call, wherein the voice path is established upon receiving the engage instruction.
